(19) United States
(12) Patent Application Publication
(10) Pub. No.: US 2009/0025055 A1
(43) Pub. Date: Jan. 22, 2009

(54) SYSTEM FOR REMOTE ACCESS OF SATELLITE MEDIA SERVICES

(75) Inventors: SCOTT WHITE, AUSTIN, TX (US); RAMSEY KSAR, SAN JOSE, CA (US)

Correspondence Address: AKERMAN SENTERFITT, P.O. BOX 3188, WEST PALM BEACH, FL, 33402-3188, US

(73) Assignees: AT&T KNOWLEDGE VENTURES, L.P., RENO, NV (US); YAHOO! INC., SUNNYVALE, CA (US)

(21) Appl. No.: 11/778,484

(22) Filed: Jul. 16, 2007

(51) Int. Cl. H04N 7/16

(52) U.S. Cl. 725/152

(57) ABSTRACT

A system for remote access of satellite communication services is disclosed. A system that incorporates teachings of the present disclosure may include, for example, a portal having a controller element to present at a communication device one or more manageable services of a satellite media receiver operating in a satellite communication system. Other embodiments are disclosed.

### FIELD OF THE DISCLOSURE

The present disclosure relates generally to satellite communication services and more specifically to a system for remote access of satellite communication services.

### BACKGROUND

Satellite media receivers can now provide HDTV programming, parental controls, video on demand (VoD) services, digital video recording (DVR) services, and numerous other features that consumers can enjoy in the privacy of their home or office. These services, however, are not easily manageable remotely.

Presently there are some accessories available for providing users remote access to satellite communication receivers in a residence or commercial enterprises. For example, a remote access media accessory such as SlingBox™ can attach to a satellite Set-Top Box (STB) and thereby provide remote control access to a mobile user by way of an Internet-capable laptop computer or Internet-capable mobile phone. An accessory such as SlingBox™ supplies an Infrared (IR) cable that attaches to the IR port of the satellite STB to control its operation. As such SlingBox™ can operate as a remote controller of the satellite STB. To complete the installation process, client software such as SlingPlayer™ is installed on the portable communication device to provide a means for remote access to the SlingBox™ tuner. Additionally, a port needs to be opened in a router of the user's home network to make available remote access to the SlingBox™ tuner over a public Internet.

Although a remote access accessory such as SlingBox™ can provide desirable features to consumers, it can be cumbersome for some consumers with lack of technical expertise to successfully complete the installation process. Additionally, such accessories can result in contention issues. For example, if someone is at home viewing a TV program while a user is operating the SlingBox™ tuner remotely with a laptop computer or mobile phone, a conflict can arise as to who controls the remote control.

A need therefore arises for a system for remote access of satellite communication services.

### BRIEF DESCRIPTION OF THE DRAWINGS

FIG. 1 depicts an exemplary embodiment of a satellite communication system;

FIGS. 2-3 depict exemplary embodiments of a portal of the satellite communication system;

FIG. 4 depicts an exemplary method operating in portions of the satellite communication system; and

FIG. 5 is a diagrammatic representation of a machine in the form of a computer system within which a set of instructions, when executed, may cause the machine to perform any one or more of the methodologies discussed herein.

### DETAILED DESCRIPTION

Broadly stated, embodiments in accordance with the present disclosure provide a system and method for remote access of media services.

In one embodiment of the present disclosure, a computer-readable storage medium in a portal can have computer instructions for receiving over an Internet connection a request from a communication device to access one or more manageable services of a satellite media receiver, and establishing communications with the satellite media receiver by way of a gateway. The gateway can be coupled to a broadband port of the satellite media receiver by way of a Local Area Network (LAN) managed by the gateway. The satellite media receiver can have a satellite port for receiving satellite signals supplied by a satellite dish system and the satellite signals can be associated with satellite media services of the satellite communication system. The storage medium can also have computer instructions for receiving from the satellite media receiver information associated with the one or more manageable services of the satellite media receiver, and presenting the one or more manageable services of the satellite media receiver at an Internet browser of the communication device by way of a Graphical User Interface (GUI). The one or more manageable services can include at least one among one or more Electronic Programming Guides (EPGs), a Video on Demand (VoD) catalog, a Digital Video Recorder (DVR), and one or more media files stored in the STB.

In one embodiment of the present disclosure, a portal can have a controller element to present at a communication device one or more manageable services of a satellite media receiver operating in a satellite communication system.

In one embodiment of the present disclosure, a satellite media receiver can have a controller element to present one or more manageable services to a portal that provides portable communications devices remote access to the one or more manageable services of the satellite media receiver.

In one embodiment of the present disclosure, a gateway can have a controller element to provide a portal access to one or more manageable services of a satellite media receiver.

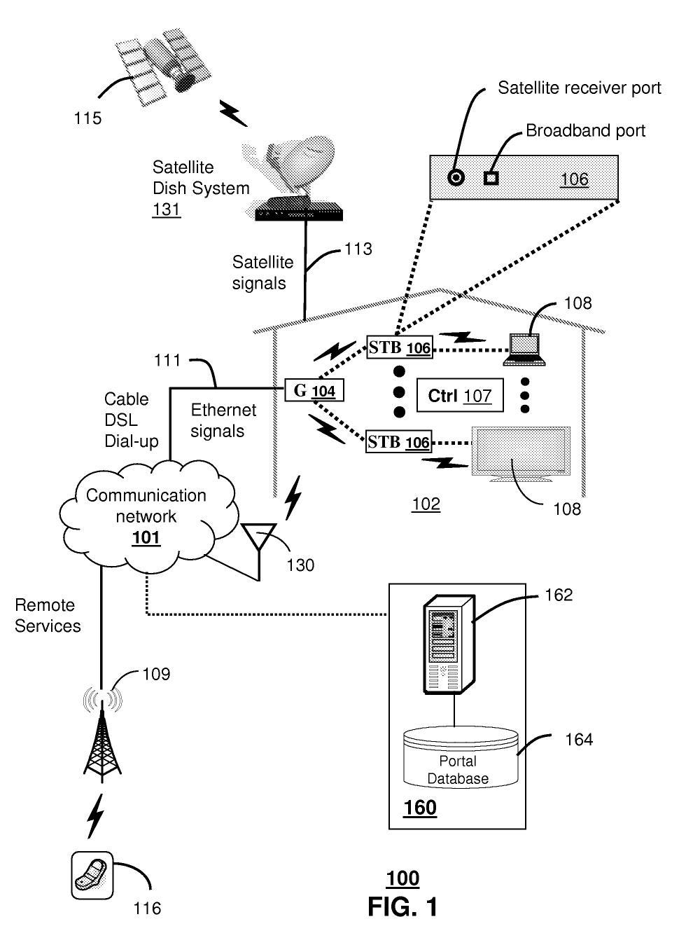

FIG. 1 depicts an exemplary embodiment of a satellite communication system 100. The satellite communication system 100 can comprise a satellite dish system 131 that delivers multimedia satellite services from one or more satellites 115 to a residence or commercial establishment (“building”) 102. A gateway 104 residing in building 102 can be used to distribute a portion of Ethernet signals 111 and satellite signals 113 to one or more satellite media receivers 106 such as satellite Set-Top Boxes (STBs) for presenting satellite multimedia services to media devices 108 such as a computer, cell phone, portable music player, or analog or digital television set (e.g., plasma TV). Alternatively, the satellite media receivers 106 can be coupled to the satellite dish system 131 and thereby receive the satellite signals 113 directly.

The satellite media receiver 106 can be supplied to subscribers by a satellite broadcast communications provider for purposes of delivering satellite media services to the media device 108. The delivery of satellite programs to the media devices 108 can be distributed by common wired (e.g., coax or optical cable) or wireless means. A media controller 107 such as a common remote controller can be used to control the satellite media receiver 106 and/or the media device 108. The media controller 107 can utilize common infrared or RF signaling technology to communicate with one or more of the aforementioned subsystems of the satellite communication system 100. The media controller 107 can also include a common display (e.g., LCD) for presenting a user interface (UI) for controlling operations of the satellite media receiver 106.

The satellite communication system 100 can utilize a portal 160 that can provide portal services to subscribers of the satellite communication system 100. The controller element 162 can utilize common computing technologies (e.g., desktop computer, server, etc.) to manage processing resources of the portal 160 and a mass storage system 164. The mass storage system 164 can utilize common storage technologies (e.g., hard disk drives, flash memory, etc.) to store data in one or more databases.

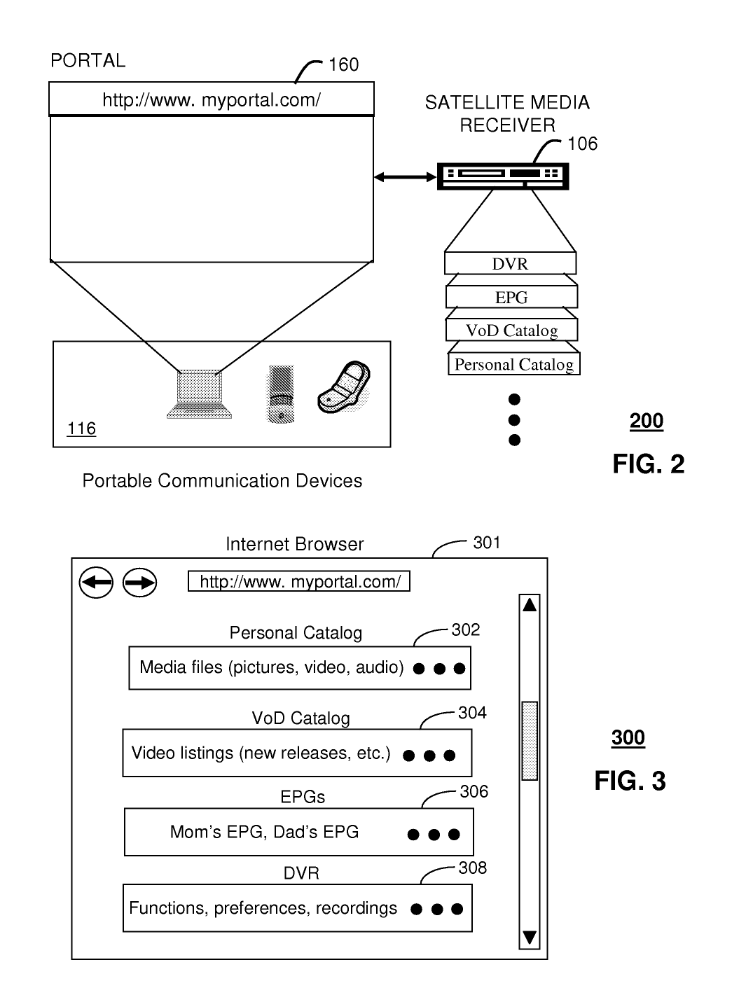

FIGS. 2-3 depict exemplary embodiments of the portal 160. In FIG. 2, the portal 160 can be accessed by a URL with a common browser such as Microsoft's Internet Explorer. The portal 160 can be configured to access a satellite media receiver 106 such as the STB of FIG. 1 and services managed thereby such as a Digital Video Recorder (DVR), an Electronic Programming Guide (EPG), Video on Demand (VoD) catalog, a personal catalog stored in a memory of the satellite media receiver 106 (e.g., personal videos, pictures, audio recordings, etc.) by way of the gateway 104. FIG. 3 depicts GUI windows 302-308 of the Internet browser 301 presented by the portal 160 using HTML language for navigating through a personal catalog stored in the satellite media receiver 106, a VoD catalog of the satellite communication system 100, EPGs (customized by the subscriber or otherwise provided by the service provider of the satellite communication system), and DVR preferences, functions and recordings, among other functions and settings.

The satellite media receiver 106 can stream information associated with an item selected from the GUI windows 302-308 such as for example a VoD program, a TV program, a DVR recording, or a media file of a personal catalog. Streamed media supplied by the satellite media receiver 106 can be presented by way of a media player (e.g., QuickTime™, Windows Media Player™, Real Player™, etc.) operating in the recipient portable communication device 116 (cell phone or laptop computer) remotely accessing the STB by way of the portal 160. The streamed media can be audio only content, video only content, and combinations thereof that can be managed by GUI controls of the media player (e.g., play, stop, rewind, etc.). The selection can take place by common means provided by common Internet browsers (e.g., mouse pointer with a selection buttons). In the case of still images, the images can be downloaded from the media receiver 116 by way of the portal 160 to the recipient communication device 116 or with resolution reformatted to improve delivery time.

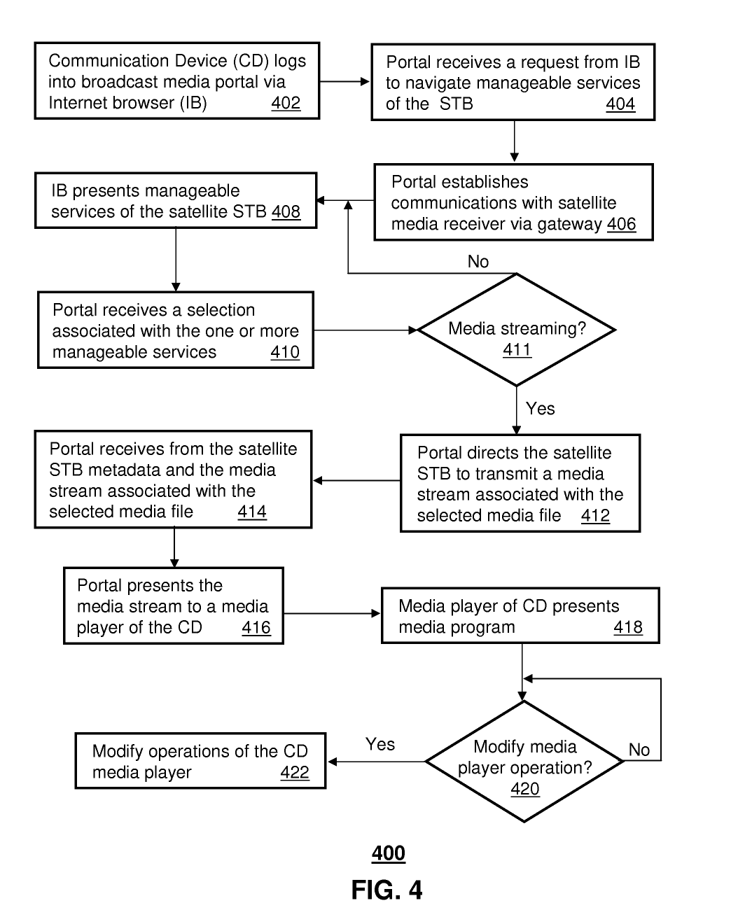

FIG. 4 depicts an exemplary method 400 operating in portions of the satellite communication system 100. Method 400 begins with step 402 in which a portable communication device 116 roaming the communication system 100 of FIG. 1 (e.g., a cell phone or lap top) logs into a broadcast media portal 160 via an Internet browser 301. The computing devices 130 operate as a web server of the broadcast media portal serving a multiplicity of subscribers of the satellite communication system 100 depicted in FIG. 1. The portal 160 can be accessed by common means (e.g., URL) and a subscriber account identified by a user's login information (e.g., username and password).

Once a subscriber has logged in, the portal 160 can be programmed to detect in step 404 a request from the Internet browser 301 to navigate one or more manageable services of the satellite media receiver 106. The request can arise from a selection of a GUI element in the portal 160 (e.g., a hypertext link or icon associated with the satellite media receiver 106) which is presented when the user logs into the portal 160 in step 402. In response to said request, the portal 160 can be programmed in step 406 to establish communications over the communication network 101with the satellite media receiver 106 by way of the gateway 104. The gateway 104 provides access to the satellite media receiver 106 over the LAN coupled to the receiver's broadband port. In this step, the portal 160 can supply authentication information to the gateway 104 to provide secure access to the satellite media receiver 106.

In step 408, the Internet browser 301 receives information from the portal 160 for presenting the manageable services of the satellite media receiver 106 by way of the GUI windows 302-308 of FIG. 3. The portal 160 can receive from the Internet browser 301 in step 410 a selection associated with the one or more manageable services of the satellite media receiver. The selection can be the result of a subscriber pointing a mouse arrow at a particular item in the GUI windows 302-308 and “double clicking” it to indicate a request for presentation of the selected item. In step 411, the portal 160 can determine if the selected item involves a media file that can be streamed to the subscriber's communication device 116. If for example the selected item is a DVR recording, a downloaded VoD program, a TV program selected from an EPG, or a personal media file that can be streamed then the portal 160 proceeds to step 412.

If on the other hand, the selected item is a navigation request to provide information associated with a TV program, navigating a hierarchy of an EPG, a VoD or personal catalog, the portal 160 proceeds to step 408 where it presents the requested item. If the item selected is a still image media file, the portal 160 can be programmed to download the media file to the portable communication device 116 and proceed to step 408. The media file can be reformatted to less resolution to improve its time of delivery.

If a streaming application can be invoked, the portal 160 proceeds to step 412 where it directs the satellite media receiver 106 to transmit a media stream associated with the selected media file stored in said receiver. In step 414 the portal 160 receives from the satellite media receiver 106 metadata (if available) of the media file and the media stream associated therewith. In step 416, the portal presents the media stream to a media player of the communication device 116 (e.g., Microsoft Windows Media Player™). The presentation can take place in step 418 by way of a graphical user interface (GUI) window of the media player that can include among other things a video or still image presentation with text derived from the metadata (e.g., name of video, song, genre, actor names, media duration, media file date, etc.).

The communication device 116 can be programmed in step 420 to modify in step 422 the operation of the media player when detecting a selection associated with the GUI control elements (e.g., play, pause, fast forward, volume control, etc.). The media player can also be programmed to buffer the media stream received from the portal 160 and begin the presentation immediately or upon selecting the play button. Selecting the pause button ceases presentation of the streamed media. Other buttons of the media player can perform well known functions.

Upon reviewing the aforementioned embodiments, it would be evident to an artisan with ordinary skill in the art that said embodiments can be modified, reduced, or enhanced without departing from the scope and spirit of the claims described below. In particular method 400 provides a means for remote access to manageable services of a satellite media receiver 106 without the complex setup procedures or use limitations of prior art systems. For instance, the satellite media receiver 106 can be designed with processing resources to perform multitasking functions. In this embodiment, the satellite media receiver 106 can be capable of presenting a portable communication device 116 access to manageable media services while another party located in building 102 is utilizing the media receiver. The present disclosure therefore provides a solution that can circumvent multiparty contention issues encountered by prior art systems.

Additionally, method 400 can be applied to multiple media devices accessible over the Internet. For example, in cases where a DVR is not an integral part of the satellite media receiver 106, services of the DVR can be managed remotely through the portal 160 so long as it can be accessed by way of the broadband port of the satellite media receiver 106 or an Internet connection within the subscriber's home LAN (e.g., WiFi, xDSL, etc.). This embodiment also overcomes the limitation in prior art systems incapable of managing media services of multiple media devices. Method 400 can also be modified so that instead of the satellite media receiver 106 streaming a media file to the portal 160, the media file is retrieved by the portal from said satellite media receiver and processing resources of the portal are used to stream the media file to the communication device 116.

These are but a few examples of modifications that can be applied to the present disclosure without departing from the scope of the claims. Accordingly, the reader is directed to the claims section for a fuller understanding of the breadth and scope of the present disclosure.

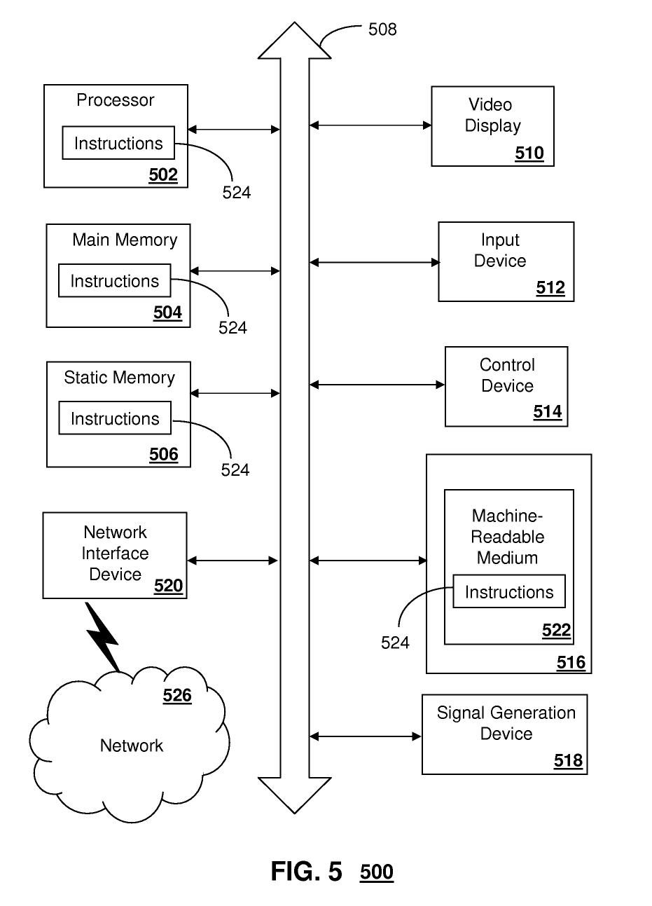

FIG. 5 depicts an exemplary diagrammatic representation of a machine in the form of a computer system 500 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 500 may include a processor 502 (e.g., a central processing unit (CPU), a graphics processing unit (GPU, or both), a main memory 504 and a static memory 506, which communicate with each other via a bus 508. The computer system 500 may further include a video display unit 510 (e.g., a liquid crystal display (LCD), a flat panel, a solid state display, or a cathode ray tube (CRT)). The computer system 500 may include an input device 512 (e.g., a keyboard), a cursor control device 514 (e.g., a mouse), a disk drive unit 516, a signal generation device 518 (e.g., a speaker or remote control) and a network interface device 520.

The disk drive unit 516 may include a machine-readable medium 522 on which is stored one or more sets of instructions (e.g., software 524) embodying any one or more of the methodologies or functions described herein, including those methods illustrated above. The instructions 524 may also reside, completely or at least partially, within the main memory 504, the static memory 506, and/or within the processor 502 during execution thereof by the computer system 500. The main memory 504 and the processor 502 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 524, or that which receives and executes instructions 524 from a propagated signal so that a device connected to a network environment 526 can send or receive voice, video or data, and to communicate over the network 526 using the instructions 524. The instructions 524 may further be transmitted or received over a network 526 via the network interface device 520.

While the machine-readable medium 522 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure.

The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the disclosure is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A computer-readable storage medium in a portal, comprising computer instructions for:
receiving over an Internet connection a request from a communication device to access one or more manageable services of a satellite media receiver;
establishing communications with the satellite media receiver by way of a gateway, wherein the gateway is coupled to a broadband port of the satellite media receiver by way of a Local Area Network (LAN) managed by the gateway, wherein the satellite media receiver comprises a satellite port for receiving satellite signals supplied by a satellite dish system, and wherein the satellite signals are associated with satellite media services of a satellite communication system;
receiving from the satellite media receiver information associated with the one or more manageable services of the satellite media receiver; and
presenting the one or more manageable services of the satellite media receiver at an Internet browser of the communication device by way of a Graphical User Interface (GUI), wherein the one or more manageable services comprise at least one among one or more Electronic Programming Guides (EPGs), a Video on Demand (VoD) catalog, a Digital Video Recorder (DVR), and one or more media files stored in the STB.

2. The storage medium of claim 1, comprising computer instructions for performing at least one among navigating through the one or more EPGs, searching through the one or more EPGs, switching between the one or more EPGs, and editing or creating the one or more EPGs.

3. The storage medium of claim 1, comprising computer instructions for managing the DVR of the satellite media receiver to perform at least one among adjusting program recording preferences, scheduling a program recording, reviewing a scheduled program recording, editing a scheduled program recording, deleting a schedule program recording, monitoring progress of a schedule program recording, resolving a conflict between scheduled program recordings, scheduling a program recording from a select one of the one or more EPGs, and viewing a scheduled program recording stored in the DVR.

4. The storage medium of claim 1, comprising computer instructions for performing at least one among browsing through the one or more media files stored in the satellite media receiver, selecting one of the one or more media files for presentation, streaming the selected media file to the communication device, editing one of the one or more media files, reordering the one or more media files, and deleting at least one of the one or more media files.

5. The storage medium of claim 4, comprising computer instructions for streaming the selected media file to the Internet browser of the communication device.

6. The storage medium of claim 1, wherein the one or more media files comprise at least one among audio, still and moving image files, and wherein the GUI window is defined by the portal according to a Hypertext Markup Language (HTML).

7. The storage medium of claim 1, comprising computer instructions for performing at least one among browsing through the VoD catalog, presenting information associated with a select item in the VoD catalog, scheduling downloads of the select item in the VoD catalog, managing downloaded content, content undergoing download or content queued for download from the VoD catalog, resolving conflicts between content download requests of the VoD catalog, and presenting a progress report of content undergoing download from VoD catalog.

8. A portal, comprising a controller element to present at a communication device one or more manageable services of a satellite media receiver operating in a satellite communication system, wherein the one or more manageable services comprise at least one among one or more Electronic Programming Guides (EPGs), a Video on Demand (VoD) catalog, a Digital Video Recorder (DVR), and one or more media files stored in the STB.

9. The portal of claim 8, wherein the controller element performs at least one among navigating through the one or more EPGs, searching through the one or more EPGs, switching between the one or more EPGs, and editing or creating the one or more EPGs.

10. The portal of claim 8, wherein the controller element manages at least one among adjusting program recording preferences, scheduling a program recording, reviewing a scheduled program recording, editing a scheduled program recording, deleting a schedule program recording, monitoring progress of a schedule program recording, resolving a conflict between scheduled program recordings, scheduling a program recording from a select one of the one or more EPGs, and viewing a scheduled program recording stored in the DVR.

11. The portal of claim 8, wherein the controller element performs at least one among browsing through the one or more media files stored in the satellite media receiver, selecting one of the one or more media files for presentation, streaming the selected media file to the communication device, editing one of the one or more media files, reordering the one or more media files, and deleting at least one of the one or more media files.

12. The portal of claim 11, wherein the one or more media files comprise at least one among audio, still and moving image files.

13. The portal of claim 8, wherein the controller element performs at least one among browsing through the VoD catalog, presenting information associated with a select item in the VoD catalog, scheduling downloads of the select item in the VoD catalog, managing downloaded content, content undergoing download or content queued for download from the VoD catalog, resolving conflicts between content download requests of the VoD catalog, and presenting a progress report of content undergoing download from VoD catalog.

14. A satellite media receiver, comprising a controller element to present one or more manageable services to a portal that provides portable communications devices remote access to the one or more manageable services of the satellite media receiver.

15. The satellite media receiver of claim 14, wherein the one or more manageable services comprise at least one among one or more Electronic Programming Guides (EPGs), a Video on Demand (VoD) catalog, a Digital Video Recorder (DVR), and one or more media files stored in the satellite media receiver.

16. The satellite media receiver of claim 14, wherein the controller element presents to the portal over a broadband port of the satellite media receiver the one or more manageable services.

17. The satellite media receiver of claim 14, wherein the controller element presents to the portal satellite metadata associated with the one or more manageable services.

18. A gateway, comprising a controller element to provide a portal access to one or more manageable services of a satellite media receiver.

19. The gateway of claim 18, wherein the one or more manageable services comprise at least one among one or more Electronic Programming Guides (EPGs), a Video on Demand (VoD) catalog, a Digital Video Recorder (DVR), and one or more media files stored in the satellite media receiver.

20. The gateway of claim 18, wherein the controller provides the portal access to the satellite media receiver media receiver upon the portal supplying valid authentication information.
